(19) United States
(12) Patent Application Publication
(10) Pub. No.: US 2009/0198605 A1
(43) Pub. Date: Aug. 6, 2009

(54) COMMUNICATION SYSTEM, A METHOD OF INITIATING A TRANSACTION, A BASE STATION AND A TRANSPONDER

(75) Inventors: Michael Ganzera, Graz (AT); Cord Bartels, Hermannsburg (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/302,581

(22) PCT Filed: May 16, 2007
(86) PCT No.: PCT/IB2007/051880

§ 371 Date: Nov. 26, 2008

(30) Foreign Application Priority Data
May 29, 2006 (EP) 06114658.5

(51) Int. Cl. G06Q 40/00

(52) U.S. Cl. 705/35

(57) ABSTRACT

A communication system (100) for initiating a transaction between a first communication device (101) and a second communication device (102), the communication system (100) comprising the first communication device (101) and the second communication device (102), wherein one of the first and second communication devices (101, 102) is adapted for generating a transaction initiation code and for transmitting the transaction initiation code to the other one of the first and second communication devices (102, 101), wherein at least one of the first and second communication devices (101, 102) is adapted for outputting output information based on the transaction initiation code to a user, wherein one of the first and second communication devices (101, 102) is adapted for receiving user information from the user, and for initiating the transaction between the first and the second communication device (101, 102) if compatibility is discovered between the transaction initiation code and the user information.

### FIELD OF THE INVENTION

The invention relates to a communication system.

Moreover, the invention relates to a method of initiating a transaction.

Furthermore, the invention relates to a base station.

Beyond this, the invention relates to a transponder.

### BACKGROUND OF THE INVENTION

In these days, the importance of identification and authentication systems and of transaction systems is ever increasing. In particular contactless identification and transaction systems like transponder systems (for instance using a smart card or an RFID tag) are suitable for a wireless transmission of data in a fast manner and without cable connections that may be disturbing. Such systems use the emission and absorption of electromagnetic waves, particularly in the high frequency domain. Particularly, contactless smart cards become more and more important. However, the wireless operation of a contactless smart card may result in security risks.

### OBJECT AND SUMMARY OF THE INVENTION

It is an object of the invention to enable a secure communication.

In order to achieve the object defined above, a communication system, a method of initiating a transaction, a base station and a transponder according to the independent claims are provided.

According to an exemplary embodiment of the invention, a communication system for initiating a transaction between a first communication device (for instance a base station, which may be or comprise an application server in the internet) and a second communication device (for instance a transponder) is provided, the communication system comprising the first communication device and the second communication device. One of the first and second communication devices may be adapted for generating a transaction initiation code (for instance a number indicative of a particular transaction) and for transmitting the transaction initiation code to the other one of the first and second communication devices, wherein at least one of the first and second communication devices is adapted for outputting output information (for instance on a display) based on the transaction initiation code (for instance identical with the transaction initiation code or derived from the transaction initiation code using a predefined algorithm) to a user, wherein one of the first and second communication devices is adapted for receiving a user information item (for instance a confirmation that the output information items output by both communication devices are in accordance with one another; or a code input by the user which serves as some kind of password for initiating the transaction, if the code is in accordance with the output information) from the user, and for initiating the transaction between the first and the second communication device if compatibility is discovered between the transaction initiation code and the user information.

In the described embodiments, any one or both of the first communication device and the second communication device may carry out any one of the described procedures of code generation and transmission, outputting output information, receiving user information, determining compatibility, and initiating the transaction.

According to another exemplary embodiment of the invention, a method of initiating a transaction between a first communication device and a second communication device is provided, the method comprising generating, by one of the first and second communication devices, a transaction initiation code and transmitting the transaction initiation code to the other one of the first and second communication devices, outputting, by at least one of the first and second communication devices, output information based on the transaction initiation code to a user, receiving, by one of the first and second communication devices, a user information item from the user, and initiating the transaction between the first and the second communication device if compatibility is discovered between the transaction initiation code and the user information.

According to another exemplary embodiment of the invention, a base station for initiating a transaction with a transponder is provided, the base station comprising a transaction initiation code generation unit for generating a transaction initiation code and for transmitting the transaction initiation code to the transponder, an output unit for outputting output information based on the transaction initiation code to a user, and an initiation unit for initiating the transaction if compatibility is discovered between the transaction initiation code and user information received from the user.

According to another exemplary embodiment of the invention, a transponder for initiating a transaction with a base station is provided, the transponder comprising a transaction initiation code receiving unit for receiving a transaction initiation code generated and transmitted from the base station, an output unit (for instance a display) for outputting output information based on the transaction initiation code to a user, and an (optional) initiation unit for initiating the transaction if compatibility is discovered between the transaction initiation code and user information received from the user.

According to another exemplary embodiment of the invention, a base station for initiating a transaction with a transponder is provided, the base station comprising a transaction initiation code receiving unit for receiving a transaction initiation code generated and transmitted from the transponder, an input unit for inputting user information by a user, and an initiation unit for initiating the transaction if compatibility is discovered between the transaction initiation code and the user information.

According to yet another exemplary embodiment of the invention, a transponder for initiating a transaction with a base station is provided, the transponder comprising a transaction initiation code generation unit for generating a transaction initiation code and for transmitting the transaction initiation code to the base station, an output unit for outputting output information based on the transaction initiation code to a user, and an initiation unit for initiating the transaction if compatibility is discovered between the transaction initiation code and user information received from the user.

According to ISO 14443, communication is usually initiated by the base station/reader, or by a corresponding application server respectively, so that the transponder sends information only on request by the reader. According to exemplary embodiments, the communication may be initiated by the reader similar to ISO 14443 or by the application server respectively. However, according to other exemplary embodiments, communication may also be initiated by the transponder.

According to still another exemplary embodiment of the invention, a program element is provided, which, when being executed by a processor unit, is adapted to control or carry out a method of initiating a transaction between a first communication device and a second communication device having the above mentioned features.

According to another exemplary embodiment of the invention, a computer-readable medium is provided, in which a computer program is stored, which, when being executed by a processor, is adapted to control or carry out a method of initiating a transaction between a first communication device and a second communication device having the above mentioned features.

Data processing, which may be performed according to embodiments of the invention, can be realized by a computer program, that is, by software, or by using one or more special electronic optimization circuits, that is, in hardware, or in hybrid form, that is, by means of software components and hardware components.

According to an exemplary embodiment of the invention, a secure communication between two communication devices may be made possible by allowing a transaction to be performed only when a user confirms directly or indirectly that two communication devices (for instance a reader device and a contactless smart card) are the correct communication partners for a specific transaction. In a scenario, in which a first communication device (like the reader device) is capable of communicating with a plurality of further communication devices (such as a plurality of present-day contactless smart cards) in the environment, such an embodiment ensures that the communication is performed between this first communication device and only an intended one of the second communication devices. For this purpose, any (for example alphanumerical) code may be exchanged between the two communication devices, for which the exchange of a communication message, which may include an instruction (a transaction), is desired. After having exchanged such a transaction initiation code, a human user may be involved in the verification procedure by requesting the user to confirm that the two communication devices, both displaying the transaction initiation code, are in fact the correct communication partners. Alternatively, one of the devices may display the code, and the user may be invited to type in this code or an unambiguously assigned code in the other one of the communication devices. Only upon agreement of the displayed code with the code input by the user, may the transaction be allowed or accepted.

The reader itself may be transparent (meaning that it passes received data to its output without changing the data). Communication may then be managed by an application server via the (public) internet (or any other network) or an application residing on a PC (for instance a home PC) connected to the reader device. Alternatively, the reader device may work autonomously, that is to say, may include all components necessary for communicating with the transponder.

As a result, machine skills and human skills may be combined in a synergetic and complementary manner, which avoids with high probability that a communication between the first communication device and a wrong one of the plurality of further communication devices is carried out. Thus, an exchange of (confidential) information or the execution of specific instructions only between the first communication device and a correct one of the second communication devices is ensured.

A problem, which occurs when using contactless smart cards, is the risk of undesired access to the card. In other words, it may happen that a smart card is read out unintentionally, and the user of the smart card does not recognize this or cannot avoid this. However, it may also happen that a user assumes that her or his smart card is read out by a reader, although this is not the case.

Exemplary embodiments of the invention particularly relate to such cases. For instance, if a user wants to electronically sign a document using a smart card via a reader device connected to a personal computer (PC). In such a scenario, in the receiving area of the reader, a plurality of smart cards (for instance related to different persons) may be present. Therefore, it can happen that the reader uses a smart card of another, wrong person for signing, for instance because this smart card provides a stronger signal than the “correct” smart card. Embodiments of the invention may allow to securely avoid such problems by displaying unambiguous information indicative of which smart card is used for signing.

According to an exemplary embodiment of the invention, the application (which may run on a remote application server, on a computer connected to the reader, or on the reader itself) generates a transaction number, and sends it (via the reader) to a smart card that was selected by the reader. This number is then displayed on a display of the reader (or on a display of the personal computer) as well as on a display of the smart card. Finally, the user confirms that both numbers are identical and thereby initiates the actual transaction. After completing the transaction, a corresponding confirmation may be displayed on the display of the smart card, for instance an information item “transaction completed”.

By such a manual confirmation of the transaction numbers, the erroneous use of any other smart card in the field of the reader for the transaction is ruled out. As an alternative to the signing of documents, other applications such as money transactions, etc. are imaginable. As an alternative to a transaction number, any desired sequence of keys (letters and/or numbers) or any graphic or image may be displayed. It is furthermore not mandatory that the numbers displayed on the smart card and on the reader be identical: it is sufficient that it is unambiguous for a human user that the numbers are uniquely correlated to one another. Such a correlation or assignment may also be realized by a “question and answer” feature or a dialog, for instance by displaying on the reader display “2+3=?”, and displaying on the smart card display “5”. It is furthermore imaginable to refer to data stored on the smart card, for instance, name or address of the owner by asking “What is your name?”, “Where do you live?”. It is also possible that the code is not indicated optically, but acoustically, or that any other human sense is used, such as the tactile sense, etc.

According to another exemplary embodiment, it is possible to display a number on the smart card, which then has to be typed in via a keypad of the reader. The number indicated on the smart card can be transmitted using a secure wireless transmission to the reader, which compares the received number with an input number. Only upon correlation of both data items, may the planned transaction be authorized.

However, before carrying out an inventive procedure as mentioned before, it is possible that a “normal” authentication between reader and smart card is performed, in which the reader and the transponder agree that a communication between the reader and the transponder shall be enabled (for instance “company PCs” with “company smart cards”). When establishing a communication network between the reader and the transponder, keys for a secure wireless transition may be exchanged between the two entities.

According to an exemplary embodiment, a method of executing a transaction between a first and a second (contactless) communicating device may be provided. According to such a method, information may be displayed on a display of the first device before the transaction. This information or uniquely assigned information may also be displayed on a display of the second device. The transaction may be carried out after a manual confirmation of the agreement or assignment. Alternatively, it is possible to manually input the information or uniquely assigned information using input elements of the second device. After such a manual input, the transaction may be carried out in case of an agreement or assignment between the input data and the correct data.

Particularly, a display on a contactless smart card may be provided as an integral part of a secure transaction environment. For instance, a secure transaction with a confirmation of a successfully completed secure transaction via a smart card display may be performed on a secure smart card with a display. The use of a contactless card with a display may thereby fulfill requirements related to contactless cards and current signal signature laws (for instance in Germany), which demand that it must be clear with which card the terminal communicates.

This is easy to determine having a contact card in a slot of a contact reader, but not when using contactless cards in the field of a reader (more than one card can be addressed, and it is not easy to tell if it is in fact the card assigned to the user for which a communication channel is established). It may happen that there is a “malicious second card hidden in the field” which performs the actual transaction (and retrieves secret information) while emulating a successful transaction to the cardholders

According to an exemplary embodiment of the invention, a display on a contactless card may be used to share a secret between the card and the terminal/background system and also indicates a successful secure transaction. Smart card security features (encryptions may be used to ensure privacy and data security) may be implemented as well in such a system. The contactless display card may become an integral part of a secure transaction environment. A possible application scenario is the mutual authentication of the card or of the cardholder by creating a session key on the card and displaying it to the user—and a background system asking for this data to be input in the system (like a pin) via a keyboard. The correctness of the pin and input and the success of the transaction can be shown on the display of the card (via sending specific commands (encrypted) to the card). By creating the access data on the secure contactless smart card, the display of the card is turned into an integral part of a security concept.

Exemplary fields of application of embodiments of the invention relate to Government public services, for instance National ID, health cards, driving licenses, etc. Applications such as digital signature, log on, secure transactions are further fields of application.

Use of authentication and identification services may be combined with user entry of PIN numbers or the like. This may occur in addition or as an alternative to the user confirmation procedure that is the basis for the initiation of the transaction according to the embodiments described previously.

Therefore, it is also possible to consider the following scenario according to exemplary embodiments of the invention: After (an optional) generic card authentication (usually carried out automatically after the card has been exposed to the reader), the card is selected. After that the communication system (for instance application server eBay) can communicate with the card and may ask the card holder for entry of a PIN and may send a message to the card's display, for example “Type PIN”. The card holder may type the PIN and can follow progress on her or his card's display (in the form of hidden information “****”, or alternatively in clear text). After verification of the PIN in the communication system, the result may be displayed on the card (and/or on reader or PC screen).

The PIN entry device may be implemented including one or any combination of the following functions:

1. PC keyboard or stand-alone keypad connected to the communication system either directly or via a PC.

2. Keypad of contactless smart card reader

3. Buttons on the smart card

More generally, it is possible to implement exemplary embodiments of the invention in a password input and verification procedure, like a PIN code input and verification. The transponder may, in such a scenario, be provided with an output unit (such as a display or a speaker) and/or with an input unit (such as one or more buttons, a keypad, a touchpad, etc.). Then, the user may be invited (via an output unit of the base station and/or via the output unit of the transponder) to input (via an input unit of the base station and/or via the input unit of the transponder) an authentication code like a PIN number. When the user inputs this code, progress of the input procedure may be output, particularly displayed, via the output unit of the base station and/or via the output unit of the transponder. This output may be in clear text or in any encrypted manner, like hidden information, for the sake of security. Then, it may be verified whether the code input by the human user is correct, and consequently a communication between the base station and the transponder may be enabled or disabled.

With regard to the previously described embodiment, the function of the base station may also be fulfilled at least partially by an application server. In such a case, the base station has the function of an interface between the application server and the transponder.

Next, further embodiments of the communication system will be explained. However, these embodiments also apply for the method of initiating a transaction, for the base stations and for the transponders.

Each of the first and the second communication device may be adapted for outputting an output information item based on the transaction initiation code to the user. According to such a scenario, the two communication devices (for instance transponder and base station) may both display a respective output information item simultaneously. The output information displayed on the two devices may be different, but may have the same origin, namely must be derived from the transaction initiation code. In other words, a unique algorithm may be used for deriving the respective output information from the transaction initiation code. The information is then visualized to the user, allowing the user to determine intuitively whether the two communication partners are the correct ones.

Still referring to such an embodiment, the user information may be an indication from the user if the items if output information output by the first and the second communication device are compatible with one another. In other words, in such a scenario in which both communicating devices display the same or correlated or assigned output information, it may be sufficient that a user simply confirms (for example by pressing a “Yes” or a “No” button) whether the two communication devices which are intended for a subsequent transaction, are correct or not. For instance, a user may then press an OK button or may express her or his agreement in another way.

Alternatively, exactly one of the first and second communication devices may be adapted for outputting the output information based on the transaction initiation code to the user. For example, the transaction number may be displayed only on a display of a transponder, but not on the reader. In such an embodiment, the user may be invited to input this number or corresponding information via an input interface (like a keypad) into the reader device. The input data may then be used as the user information that defines whether a communication of these two devices is allowed or not. Even in such an embodiment, the interaction of a user with the machine may ensure that the two communication devices identified for carrying out the transaction are the correct ones.

The one of the first and second communication devices transmitting the transaction initiation code to the other one of the first and second communication devices may transmit the transaction initiation code together with an address code which is uniquely indicative of the other one of the first and second communication devices. In other words, a reader device or a base station ensures that a desired communication partner is addressed with the communication message including the transaction initiation code. Therefore, by sending the transmission initiation code to a specifically addressed receiver, the degree of security may be further increased.

At least one of the first and second communication devices may be adapted for outputting the output information in at least one manner of the group consisting of a visual output and an audible output. For instance, the corresponding output information may be displayed on a display device of the base station (for instance on a monitor) or of the transponder (for instance on an LCD display of a smart card or by use of the electronic ink technology). Such an output may be performed in such a manner that the output is perceivable by a human user (using any of the human senses), for instance by the visual sense or the audible sense.

At least one of the first and second communication devices may be adapted for outputting transaction confirmation information to the user confirming if the transaction between the first and the second communication device has been initiated with success or not. For instance, if a transaction has been allowed (because the above-described scheme has been performed successfully), corresponding information like “transaction completed” may be displayed. Alternatively, if the procedure has not been finished successfully, information like “transaction not completed” or the like may be displayed, inviting a user to try the desired transaction again or to indicate that an error has occurred.

The communication system may be adapted for initiating a wireless transaction between the first communication device and the second communication device. In case of a wired connection, the risk of a transaction between a base station and a “wrong” transponder is relatively small. However, particularly in the case of a wireless transaction, such a risk is much larger, since a plurality of potential communication partners for a base station may be present in an environment. Therefore, the implementation of the system in a wireless communication scheme may be particularly advantageous.

The transponder may be a radio frequency identification tag (RFID) or a (for instance contactless) smart card.

An RFID tag may comprise a semiconductor chip (having an integrated circuit), in which data may be programmed or rewritten, and a high-frequency antenna matched to an operation frequency band used (for example 13.56 MHz). Besides the RFID tag, an RFID system may comprise a read/write device (i.e. a base station) and a system antenna enabling a bi-directional wireless data communication between the RFID tag and the read/write device. Here capacitive as well as inductive coupling is imaginable, that is to say, the use of a monopole, dipole, or loop antenna. Additionally, an input/output device (for instance a computer) may be used to control the read/write device. Different types of RFID systems are referred to, namely active RFID systems (supplied by a battery) and passive RFID systems (supplied with energy via the RF field). Moreover, semi-active (semi-passive) systems which are passively activated and in which a battery is used on demand (for instance for transmitting data) are available.

A smart card or chip card can be a tiny secure cryptoprocessor embedded within a credit card-sized card or within an even smaller card, like a GSM card. A smart card usually does not contain a battery, but is powered by a card reader/writer, that is to say, by a read and/or write device for controlling the functionality of the smart card by reading data from the smart card or by writing data in the smart card. A smart card device may particularly be used in the areas of finance, security access and transportation. Such smart cards may contain high-security processors that function as a security storage of data like card holder data (for instance name, account numbers, a number of collected loyalty points). Access to these data may only be made possible when the card is inserted into a read/write terminal and when the transaction verification procedure according to exemplary embodiments has been finished successfully.

The transponder may comprise a display unit for visually outputting at least one of the group consisting of the output information and the transaction confirmation information to the user. For instance, the transponder may be a contactless smart card on which an LCD display or the like may be provided. Via this display unit, information may be displayed making it possible to increase security of a communication with a base station.

Furthermore, the transponder may comprise an input unit (like one or more buttons, a keypad, etc.) for receiving the user information from the user. In other words, a human user may input or type in this information directly on the transponder.

The base station may comprise a wireless communication unit comprising an antenna element. Therefore, the base station or communication partner device may be adapted for wireless communication with the transponder, wherein the antenna element may be a loop antenna or a dipole antenna.

The base station may be adapted as at least one of a reader device for reading data from a memory of the transponder, a write device for writing data into the memory, and a reader/writer device for reading data from the memory and for writing data into the memory. Thus, the base station may be a base station for communication with a transponder such as a smart card or an RFID tag. It is also possible that the base station acts as an interface device to provide an interface for a communication between the second communication device (for instance a transponder) and a computer. Such a computer may be connected directly to the base station or may be a remote computer communicating with the second communication device (for instance a transponder) via a network, particularly via the internet or via any (for instance company-internal) intranet. When the base station functions (only or partly) as an interface, the actual transaction may be controlled by the connected computer.

Embodiments of the invention may be particularly applied in the service sector, in the field of logistics, in the field of commerce and in the field of industrial production. Further applications of transaction systems are related to the identification of persons and animals.

In particular contactless transaction systems are suitable for a wireless transmission using exemplary embodiments of the invention. Such systems use the emission and absorption of electromagnetic waves, particularly in the high-frequency domain (for instance around 13.56 MHz in the case of an RFID tag).

The communication between different components of the base station or between the base station and further devices may be carried out in a wired manner (for instance using a cable) or in a wireless manner (for instance via a RF communication or infrared communication).

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment, to which the invention is not limited.

FIG. 1 to FIG. 3 show communication systems according to examples of embodiment of the invention.

### DESCRIPTION OF EMBODIMENTS

The illustration in the drawings is schematic. In different drawings, similar or identical elements are provided with the same reference signs.

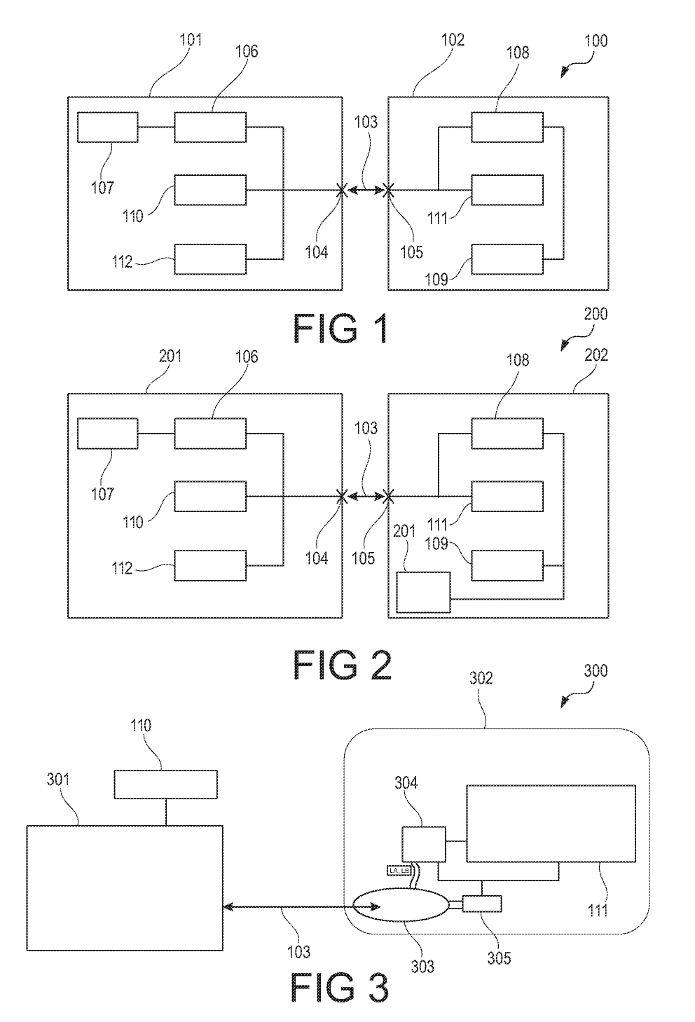

FIG. 1 shows a communication system 100 according to an exemplary embodiment of the invention.

The communication system 100 is adapted for initiating a transaction (for instance in the context of a money transaction) between a base station 101 and a contactless smart card 102.

According to the described embodiment, the base station 101 is adapted for generating a transaction initiating code (for instance a “pin” number, an alphanumerical code, or the like) and for transmitting the transaction initiation code in a wireless manner via a wireless communication channel 103 to the contactless smart card 102. For this purpose, a first wireless communication interface 104 is provided on the base station 101, and a second wireless communication interface 105 is provided at the contactless smart card 102. In the present scenario, a CPU (central processing unit) or other control unit 106 of the base station 101 generates such an alphanumerical transaction initiation code, stores the latter in an assigned memory device 107 (for instance an EEPROM), and transmits the alphanumeric transaction initiation code to a control unit 108 of the contactless transponder 102. The control unit 108 of the contactless transponder 102 stores the transmitted transaction initiation code in a memory 109 (for instance in an EEPROM).

Furthermore, the transaction initiation code is displayed as output information on a display unit 110 (e.g. an LCD or a LED) of the base station 101. At the same time, the transaction initiation code is displayed as output information also on a display unit 111 (e.g. an LCD or an electronic ink display) of the contactless smart card 102. Therefore, a human user may compare the indicated information displayed on the display units 110 and 111 as a basis for a decision whether the two devices 101, 102 are the correct devices for performing the planned transaction or not.

Therefore, the human user may confirm the correctness of the planned transaction by pressing an “OK” button using an input device 112 of the base station 101. The input unit 112 may comprise any kind of input elements, like a keypad, a joystick, a trackball, buttons, or even a microphone of a voice recognition system. Additionally or alternatively, such input elements for confirming the correctness of the two communication partners 101, 102 may also be provided on the smart card 102 (for example a “Yes” button and a “No” button).

After having confirmed the correctness of the planned transaction, the transaction is carried out, and a communication message 103 is transmitted between the communication devices 101, 102 for carrying out this transaction.

As an alternative to the described embodiment, it is also possible that the transaction initiation code is generated in the CPU 108 of the contactless smart card 102. Furthermore, this information may be transmitted from the contactless smart card 102 to the base station 101. The confirmation of the correctness of the information displayed on the displays 110 and 111 may, as an alternative to the confirmation via the input unit 112 of the base station 101, also be performed via an input unit, which may be optionally provided on the contactless smart card 102.

When the transaction has been performed, it is possible for one or both of the display units 110, 111 to display transaction confirmation information such as “transaction completed successfully”.

Although not explained above, before initiating the transaction between the devices 101, 102, it is imaginable that the communication devices 101, 102 carry out an authentication procedure for establishing a communication prior to the initialization of the transaction. Such an authentication may include the exchange of passwords, an encryption scheme, unique identifiers, etc.

FIG. 2 shows a communication system 200 according to another exemplary embodiment of the invention.

With respect to the hardware, the communication system 200 differs from the communication system 100 in that an input unit 201 is provided also on the contactless smart card 202. However, the input unit 201 is optional and may be omitted.

In the following, a scheme for initiating a transaction between the devices 201, 202 will be explained.

Again, the base station 201 may generate a transaction initiation code and transmit the transaction initiation code to the contactless smart card 202. Alternatively, the transponder 202 may generate a transaction initiation code and transmit the transaction initiation code to the base station 201.

In the scenario described referring to FIG. 2, output information is displayed only on the display unit 111 of the contactless smart card 202, not on the display unit 110 of the base station 201. For instance, an alphanumerical code is displayed on the display unit 111, and the user is invited to type in this code (or a corresponding code) via a keypad 112 of the base station 201. After having entered such user information, the devices 201, 202 check (for instance by exchanging a communication message) whether the input information (received via the keypad 112) correlates with the output information (displayed by the display 111), and if this is the case, the transaction may be initiated.

FIG. 3 illustrates a further secure transaction system 300 using a contactless display smart card.

A secure reader and background system 301 including a display 110 is adapted for a contactless communication 103 with a secure contactless smart card 302. The smart card 302 comprises an antenna 303, a SmartMX unit 304, a control unit 305, and a display 111. The display 111 of the smart card 302 may be used to display the output information. The SmartMX unit 304 is provided as a contactless interface, which is compatible with the contactless interface standard ISO 14443 A and with Philips Semiconductors' installed base of MIFARE card and reader ICs.

Finally, it should be noted that the above-mentioned embodiments illustrate rather than limit the invention, and that those skilled in the art will be capable of designing many alternative embodiments without departing from the scope of the invention as defined by the appended claims. In the claims, any reference signs placed in parenthesis shall not be construed as limiting the claims. The words “comprising” and “comprises”, and the like, do not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

1. A communication system for initiating a transaction between a first communication device and a second communication device, the communication system comprising:
the first communication device; and
the second communication device;
wherein one of the first and second communication devices is adapted for providing a transaction initiation code to the other one of the first and second communication devices;
wherein at least one of the first and second communication devices is adapted for outputting output information based on the transaction initiation code to a user;
wherein one of the first and second communication devices is adapted for receiving user information from the user, and for initiating the transaction between the first and the second communication device if compatibility is discovered between the transaction initiation code and the user information.

2. The communication system of claim 1, wherein each of the first and the second communication device is adapted for outputting respective output information based on the transaction initiation code to the user.

3. The communication system of claim 2, wherein the user information is an indication from the user whether the output information output by the first and the second communication device are compatible to one another.

4. The communication system of claim 1, wherein exactly one of the first and second communication devices is adapted for outputting the output information based on the transaction initiation code to the user.

5. The communication system of claim 1, wherein the one of the first and second communication devices providing the transaction initiation code to the other one of the first and second communication devices provides the transaction initiation code together with an address code which is uniquely indicative of the other one of the first and second communication devices.

6. The communication system of claim 1, wherein the output information is output in at least one manner of the group consisting of a visual output and an audible output.

7. The communication system of claim 1, wherein at least one of the first and second communication devices is adapted for outputting transaction confirmation information to the user confirming whether the transaction between the first and the second communication device has been initiated successfully.

8. The communication system of claim 1, wherein the first and the second communication devices are adapted for carrying out an authentication for establishing a communication prior to the initialization of the transaction.

9. A method of initiating a transaction between a first communication device and a second communication device, the method comprising the steps of:
providing, by one of the first and second communication devices, a transaction initiation code to the other one of the first and second communication devices;
outputting, by at least one of the first and second communication devices, output information based on the transaction initiation code to a user; and
receiving, by one of the first and second communication devices, user information from the user, and initiating the transaction between the first and the second communication device if compatibility is discovered between the transaction initiation code and the user information.

10. A base station for initiating a transaction with a transponder, particularly with a transponder of claim 11, the base station comprising:
a transaction initiation code generation unit for generating a transaction initiation code and for transmitting the transaction initiation code to the transponder;
an output unit for outputting output information based on the transaction initiation code to a user; and
an initiation unit for initiating the transaction if compatibility is discovered between the transaction initiation code and user information received from the user.

11. A transponder for initiating a transaction with a base station, particularly with a base station of claim 10, the transponder comprising:
a transaction initiation code receiving unit for receiving a transaction initiation code generated and transmitted by the base station;
an output unit for outputting output information based on the transaction initiation code to a user; and
an initiation unit for initiating the transaction in case of compatibility between the transaction initiation code and user information received from the user.

12. A base station for initiating a transaction with a transponder, particularly with a transponder of claim 13, the base station comprising:
a transaction initiation code receiving unit for receiving a transaction initiation code generated and transmitted from the transponder;
an input unit for inputting user information by a user; and
an initiation unit for initiating the transaction if compatibility is discovered between the transaction initiation code and the user information.

13. A transponder for initiating a transaction with a base station, particularly with a base station of claim 12, the transponder comprising:
a transaction initiation code generation unit for generating a transaction initiation code and for transmitting the transaction initiation code to the base station;
an output unit for outputting output information based on the transaction initiation code to a user; and
an initiation unit for initiating the transaction if compatibility is discovered between the transaction initiation code and user information received from the user.
